(19) United States
(12) Patent Application Publication
(10) Pub. No.: US 2011/0287231 A1
(43) Pub. Date: Nov. 24, 2011

(54) HEAT PROTECTION FOR LOAD BEARING COMPONENT

(75) Inventors: Phillip TAYLOR, Shefford (GB); Max-Rudolf BERLINGER, Eltville (DE); Alfred SCHAAD, Ludwigshoehe (DE)

(73) Assignee: GM GLOBAL TECHNOLOGY OPERATIONS LLC, Detroit, MI (US)

(21) Appl. No.: 13/112,885

(22) Filed: May 20, 2011

(30) Foreign Application Priority Data
May 21, 2010 (GB) 1008498.6

(51) Int. Cl. B32B 3/20; F16M 13/00

(52) U.S. Cl. 428/188; 248/309.1

(57) ABSTRACT

A load-bearing engine mounting bracket has a main region, which carries the loads and stresses, and a separate region which is load-free and which is exposed to heat from a heat source, e.g., an exhaust pipe. The region is in the form of a heat shield, integrally connected with region by elements, but otherwise separated from region by an air gap. The bracket is of a composite plastics material and may have a heat reflective coating. The air gap can be omitted.

### CROSS-REFERENCE TO RELATED APPLICATION

This application claims priority to British Patent Application No. 1008498.6, filed May 21, 2010, which is incorporated herein by reference in its entirety.

### TECHNICAL FIELD

The technical field relates to components that are subject to loads and stresses in use, for example the mounting brackets for the various parts of an automotive powertrain, and in particular to the provision of heat protection therefor. To keep down the weight of the vehicle, such brackets may be made of a composite plastic material. Because of their location, such brackets may be exposed to high temperatures. Composite plastic materials, however, can lose a significant amount of their strength at high temperatures. The present invention relates to protecting such components from the effects of heat, for example by providing a heat shielding member.

### BACKGROUND

US 2006/0138300 discloses a heat shield for an engine mount. The heat shield comprises a polyester substrate wrapped around the engine mount. The heat shield has integral attachment members and a heat reflecting coating. U.S. Pat. No. 6,129,328 discloses an engine mount including an elastomeric block protected by a heat shield attached thereto. The heat shield is of polymer material. In both these arrangements, the heat shield is a separate component involving additional weight and necessitating additional assembly steps.

Therefore, aspects seek to overcome or at least reduce one or more of the above problems. In addition, other aspects, desirable features and characteristics will become apparent from the subsequent summary and detailed description, and the appended claims, taken in conjunction with the accompanying drawings and this background.

### SUMMARY

According to an embodiment there is provided a load-bearing or load-transmitting component having a main, load-bearing or load-transmitting, region and an integral surface region which is disposed or configured to be substantially free of loads. Because the surface region is in a relatively understressed part of the component, it is capable of withstanding much higher temperatures, even approaching the melting point of the material for short periods. The main region continues throughout to bear and/or transmit loads and stresses in an uninterrupted manner. Since the surface region is integral with the main region, the entire component can be produced in a single molding operation, which simplifies manufacture.

The surface region can be located at a spacing or gap from the main region and connected thereto by one or more connection elements. This construction ensures that substantially no mechanical loads are transferred via the surface region and also ensures a good thermal isolation of the surface region from the main region. The surface and main regions can have a uniform composition throughout, which facilitates manufacture of the component.

The component is preferably made of a thermally insulating material. This has the advantage of minimizing heat transfer from a major surface of the surface region, which is arranged to face a heat source, to an opposite major surface of the surface region which is arranged to face the main region. In addition, thermal conduction is very low.

According to a second embodiment, there is provided a component having a main, load-bearing or load-transmitting, region and a surface region which is located at a spacing from the main region and is connected thereto by one or more connection elements.

According to a third embodiment, there is provided a combination of a heat source and a component subjected to the heat therefrom, wherein, to protect the component from thermal effects, the region of the component facing the heat source is constituted by a heat shield located at a spacing or gap from the rest of the component.

### BRIEF DESCRIPTION OF THE DRAWINGS

The present invention will hereinafter be described in conjunction with the following drawing figures, wherein like numerals denote like elements, and:

FIG. 1 shows a side view of a mount bracket in accordance with a first embodiment for part of the powertrain of a vehicle;

FIG. 2 shows a schematic view of a component in accordance with a second embodiment; and

FIG. 3 shows a schematic view of a component in accordance with a third embodiment.

### DETAILED DESCRIPTION

The following detailed description is merely exemplary in nature and is not intended to limit application and uses. Furthermore, there is no intention to be bound by any theory presented in the preceding background or summary or the following detailed description.

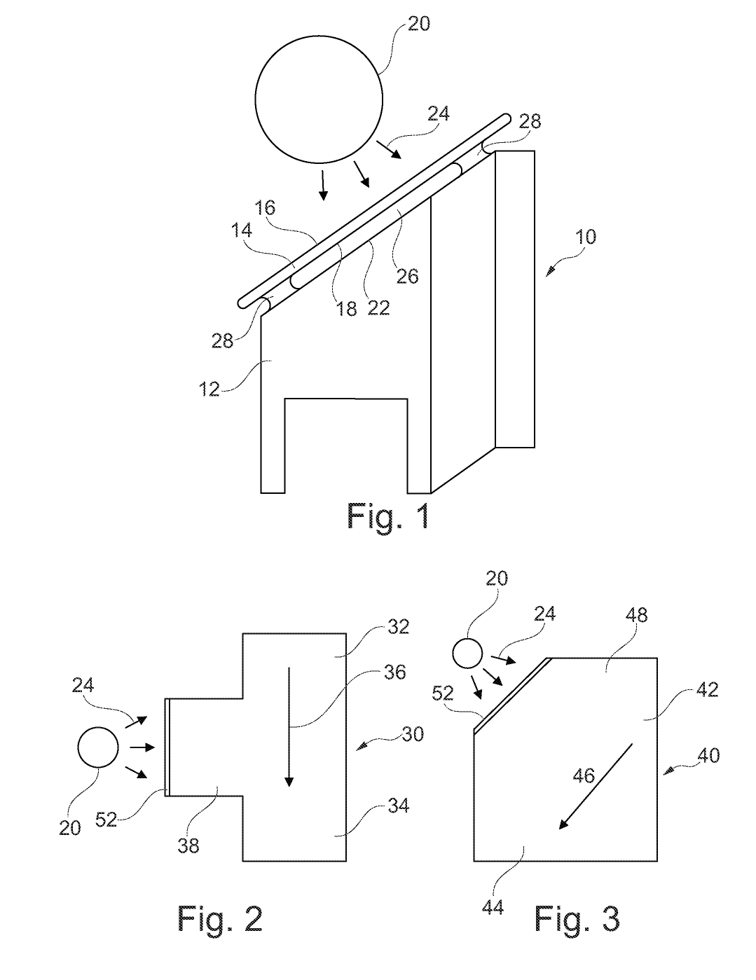

Referring to FIG. 1, a mount bracket 10 for supporting a part (not shown) of a vehicle powertrain is located adjacent a heat source associated with the engine, e.g. an exhaust pipe 20. The bracket 10 comprises a main portion 12 and a heat shield portion 14, which is located at the side of the main portion facing the heat source 20. Portion 14 has a first major surface 16 facing the heat source and a second major surface 18 facing the surface 22 of the main portion which is closest to the heat source. Surfaces 18 and 22 are separated by an air gap 26. Portion 14 is held in position on portion 12 by connecting elements 28.

The main body portion 12, heat shield portion 14 and connecting elements 28 are produced in a single injection molding operation. The bracket 10 has a uniform composition throughout. The material used is a glass fiber reinforced heat stabilized polyamide resin, preferably PA66-GF50. A heat-reflecting coating (not shown), such as silver or white paint, is applied to surface 16 to reduce the amount of heat, indicated by arrows 24, entering the bracket 10.

The above-described component 10 has several advantages. Being of integral construction with a uniform composition throughout leads to ease of manufacture. By ensuring that the hottest part of the component is not subjected to stresses or loads, it can withstand the heat 24 from source 20 and protect the rest of the component. The low thermal conductivity of the material of the component ensures minimal conduction of heat across connection elements 28. Air gap 26 also serves to protect main body portion 12 from the heat. The dimensions and operating parameters of the component can be selected according to its specific operational requirements.

Embodiments enable composite plastic material to be utilized for functional components where otherwise the high temperatures would prevent this. The integral heat shield generally has lower cost and weight than a separately fitted part, whether made from metal or other material. It also reduces the part count and avoids the need for additional fastenings and assembly time.

Various modifications can be made to the above-described component. For example, any convenient number of connecting elements 28 may be provided between portion 12 and 14, e.g. one, three or more than three. Instead of a reflective coating, surface 16 may be provided with a coating to improve its thermal resistance and/or to minimize surface oxidation and degradation. Alternatively, surface 16 may have no coating at all, which simplifies manufacture. Surface 18 and/or surface 22 may also be provided with coatings of the above types.

The composition of the component 10 may differ in different regions thereof, but this increases the complexity of manufacture. Other thermally-insulating materials may be used for component 10.

The component 10 can be of a heat-conducting material, such as a metal. The portions 12 and 14 can be made separately and subsequently connected by elements 28 of thermally insulating material. Such components are more expensive to produce.

The air gap 26 is optional. For example, FIG. 2 shows a component 30 having sub-regions 32, 34 for the respective introduction and transmission of mechanical loads and stresses. The path of the loads is indicated by arrow 36. A separate sub-region 38 of component 30 spaced laterally from the load path 36 serves as a heat shield to protect the rest of the component from the effects of heat from a heat source 20. The sub-region 38 is preferably provided with a coating 52, of one of the types discussed in connection with the embodiment of FIG. 1.

FIG. 3 shows a modification of the component of FIG. 2. In component 40, forces or loads pass between generally mutually-perpendicular surfaces of sub-regions 42 and 44, as indicated by arrow 46. Here, sub-region 48 located laterally from path 46 serves as a heat shield to protect the rest of the component from heat source 20. Again, a coating 52 is preferably provided. Instead of a straight surface, sub-region 48 may have a curved surface.

The component can be another engine component instead of a bracket. Indeed, it can be any functional component, especially a functional plastic component.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A load-bearing component, comprising:
a main load-bearing region; and
an integral surface region that is substantially free of loads.

2. The load-bearing component according to claim 1, wherein the integral surface region is located at a spacing from the main load-bearing region and connected to the main load-bearing region by a connection element.

3. The load-bearing component according to claim 1, wherein the main load-bearing region comprises:
a load-receiving sub-region;
a load-imparting sub-region; and
a load path extending between the load-receiving sub-region and the load-imparting sub-region and the integral surface region is spaced laterally from the load path.

4. A component, comprising:
a main region; and
a surface region located at a spacing from the main region and connected to the main region by a connection element.

5. A component according to claim 4, wherein the surface region is integrally constructed with the main region.

6. A component according to claim 4, wherein the surface region and the main region are formed of the same composition.

7. A component according to claim 4, further comprising a coating on the surface region.

8. A combination, comprising:
a heat source; and
a component subjected to heat from the heat source,
wherein a region of the component facing the heat source is constituted by a heat shield located at a spacing or gap from a remainder of the component to protect the component from thermal effects.

9. A combination according to claim 8, wherein the heat shield is integrally constructed with the remainder of the component.

10. A combination according to claim 8, wherein the component is formed of a thermally insulating material.

11. A combination according to claim 8, wherein the component is formed of a composite plastic material.

12. A combination according to claim 8, wherein the heat shield is connected to the remainder of the component by a connection element.

13. A combination according to claim 8, wherein the heat shield comprises a coating.
